(19) United States
(12) Patent Application Publication
(10) Pub. No.: US 2012/0226556 A1
(43) Pub. Date: Sep. 6, 2012

(54) SHOPPING CART AND METHOD

(75) Inventors: Yuya Itagaki, Izu-shi (JP); Yasuhiko Mochida, Numazu-shi (JP); Shigeaki Suzuki, Mishima-shi (JP); Kanya Hiroi, Yokohama-shi (JP); Mahina Nakamura, Musashino-shi (JP); Tsuyoshi Gotanda, Ota-ku (JP)

(73) Assignee: TOSHIBA TEC KABUSHIKI KAISHA, Tokyo (JP)

(21) Appl. No.: 13/406,988

(22) Filed: Feb. 28, 2012

(30) Foreign Application Priority Data
Mar. 2, 2011 (JP) 2011-045621

(51) Int. Cl. G06Q 30/02

(52) U.S. Cl. 705/14.64

(57) ABSTRACT

According to one embodiment, a shopping cart includes a cart, a display, a registration and a display control unit. The cart configured to convey commodities. The display mounted on the cart. The registration unit configured to register a customer who operates the cart. The display control unit configured to display on the display premium infatuation indicating premium which is offered to the customer registered by the registration unit within the premiums offered to customers when purchasing commodity.

### CROSS-REFERENCE TO RELATED APPLICATION

This application is based upon and claims the benefit of priority from Japanese Patent Application No. 2011-045621, filed Mar. 2, 2011, the entire contents of which are incorporated herein by reference.

### FIELD

Embodiments described herein relate generally to a shopping cart and a method.

### BACKGROUND

Conventionally, there is a shopping cart, used by a customer in a supermarket or a shopping mall, on which a scanner is arranged to enable the user to read the commodity code attached to a commodity. A display is arranged on such a shopping cart on which the commodity name and the unit price of a commodity of which commodity code is readout are successively displayed in the form of a list.

### BRIEF DESCRIPTION OF THE DRAWINGS

FIG. 1 is a diagram roughly illustrating the system structure of a checkout system according to an embodiment;

FIG. 2 is a perspective view of a shopping cart;

FIG. 3 is a block diagram illustrating the hardware structure of a cart terminal;

FIG. 4 is a block diagram illustrating the hardware structure of a location detector;

FIG. 5 is a block diagram illustrating the hardware structure of a shop server;

FIG. 6 is a diagram illustrating the data structure of a category master file;

FIG. 7 is a diagram illustrating the data structure of a commodity master file;

FIG. 8 is a diagram illustrating the data structure of a customer master file;

FIG. 9 is a diagram illustrating the data structure of a leaflet master file;

FIG. 10 is a diagram illustrating the data structure of a leaflet data file;

FIG. 11 is a block diagram illustrating the hardware structure of a POS (Point of Sales) terminal;

FIG. 12 is a block diagram illustrating the hardware structure of an upper server;

FIG. 13 is a diagram illustrating the data structure of a cart location information file;

FIG. 14 is a flowchart of a processing starting from the borrowing of a shopping cart and ending to the settlement of commodities in the settlement system according to the embodiment;

FIG. 15 is a diagram illustrating an example of a lending registration screen for the lending registration of a shopping cart;

FIG. 16 is a diagram illustrating an example of a shopping list generation screen showing all categories;

FIG. 17 is a diagram illustrating an example of a shopping list generation screen showing all subcategories;

FIG. 18 is a diagram illustrating an example of a shopping list generation screen showing all commodity names;

FIG. 19 is a diagram illustrating an example of a shopping list generation screen showing a leaflet image;

FIG. 20 is a diagram illustrating an example of a shopping list generation screen showing a commodity name input field;

FIG. 21 is a diagram illustrating an example of a shopping list generation screen showing all the retrieved commodity names;

FIG. 22 is a diagram illustrating an example of a shopping list generation screen showing map information;

FIG. 23 is a diagram illustrating an example of a shopping list generation screen showing route information;

FIG. 24 is a diagram illustrating an example of a shopping list generation screen showing route information; and

FIG. 25 is a diagram illustrating an example of a pop-up display on the shopping list generation screen on which the advertisement information and the limited-premium information are displayed.

### DETAILED DESCRIPTION

According to one embodiment, a shopping cart includes a cart, a display, a registration and a display control unit.

The cart configured to convey commodities. The display mounted on the cart. The registration unit configured to register a customer who operates the cart. The display control unit configured to display on the display premium information indicating premium which is offered to the customer registered by the registration unit within the premiums offered to customers when purchasing commodity.

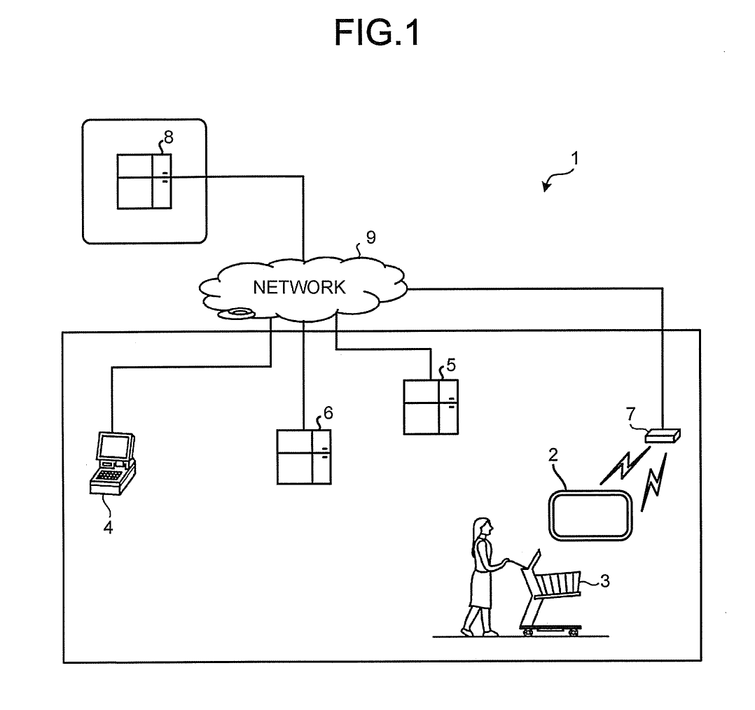

FIG. 1 is a diagram roughly illustrating the system structure of a checkout system according to an embodiment. As shown in FIG. 1, the checkout system 1 connects, via a network, a plurality of shopping carts 3 having a cart terminal 2, a POS (Point Of Sales) terminal 4 for the settlement of a customer, the shop server 6 serving as an upper device installed at the backyard of a shop, a location detector 5 for detecting locations of the shopping carts 3 in the shop and an upper server 8 for managing locations of the shopping carts 3 detected by the location detector 5. The cart terminal 2 mounted on the shopping cart 3 is connected with the network 9 via a wireless communication unit 7 set on the ceiling of the shop to communicate wirelessly with the location detector 5, the shop server 6, the POS terminal 4 and the upper server 8.

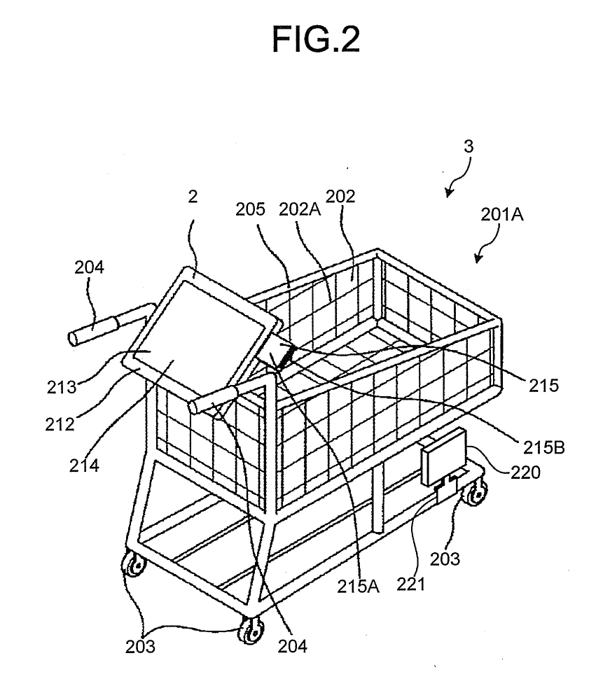

In a shop installed with such a checkout system 1, the customer borrows a shopping cart 3 at the entrance of the shop and then takes a desired commodity off a commodity shelf (not shown) . A commodity code, such as a barcode, is attached on the commodity. The customer uses a scanner 215 (referring to FIG. 2) installed on the cart terminal 2 of the shopping cart 3 to read the commodity code and then places the commodity in the storage unit 202 (referring to FIG. 2) of the shopping cart 3. After reading the commodity codes of all desired commodities and placing the commodities in the storage unit 202, the customer moves to the POS terminal 4 for a settlement. And then, the customer bags up the commodities, returns the shopping cart 3 and leaves from the exit of the shop.

FIG. 2 is perspective view of the shopping cart. The shopping cart 3 comprises a basket-shaped storage unit 202 with an opened upper surface, a caster unit 203 for moving arranged under the storage unit 202, a handle unit 204, connected with the storage unit 202, which is grasped by the customer to move the shopping cart 3 and a cart 201a for conveying commodities. Moreover, the cart 201a is constructed in a full skeleton structure with a frame 205. A net 202a is arranged between the frames 205 forming the storage unit 202 so that the commodities housed in the storage unit 202 can be recognized from the outside. In this way, a shop clerk can easily recognize details of the commodities housed in the storage unit 202. Moreover, the cart 201a, which may be provided with no storage unit 202, may be further provided with a basket support unit to support a shopping basket through which the commodities can be recognized from the outside, and the shopping basket supported by the basket support unit can be taken as the storage unit 202.

A Radio Frequency Identification (RFID) reader/writer 220 is arranged, via a supporting unit 221, on the side of the frame 205 forming the storage unit 202 where the caster unit 203 is provided. The RFID reader/writer 220 reads commodity shelf information from a shelf label (not shown) on a commodity shelf in the shop. The commodity name and the price of the commodity displayed on the shelf are displayed on the shelf label, and the shelf label is provided with an RFID tag which stores commodity shelf information for specifying the shelf arranged in the shop.

Moreover, a cart terminal 2 is arranged, via a supporting unit (not shown), on the side of the frame 205 forming the storage unit 202 where the handle unit 204 is provided. The cart terminal 2 has a housing 212, on which an LCD (Liquid Crystal Display) 213 arranged as a display, a touch panel 214 arranged on the display surface of the LCD 213 as an input unit, and a scanner 215 arranged as a commodity code reader are provided. The scanner 215 has a scanner housing 215a in which an LED (Light Emitting Diode) for lighting (not shown), a CCD (Charged Coupled Device) image sensor (not shown) , and a decoder (not shown) are arranged, and a reading window 215a is arranged at one end of the scanner 215 to read a commodity code from a barcode.

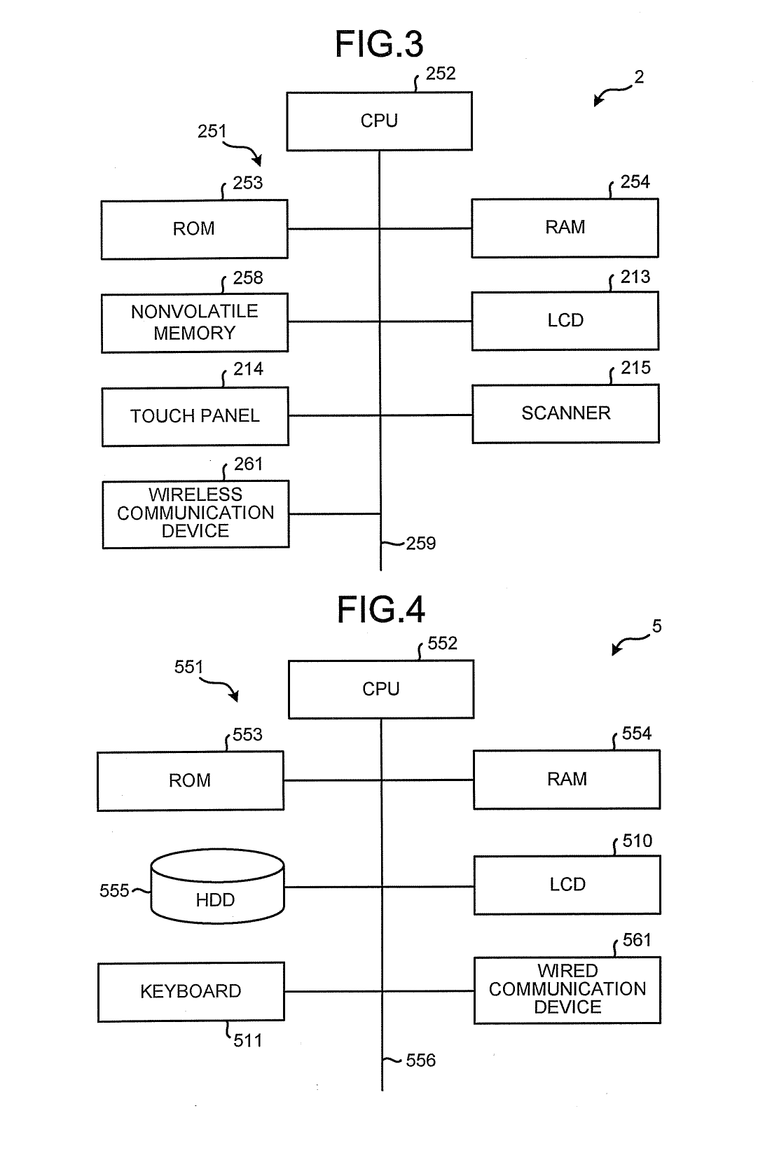

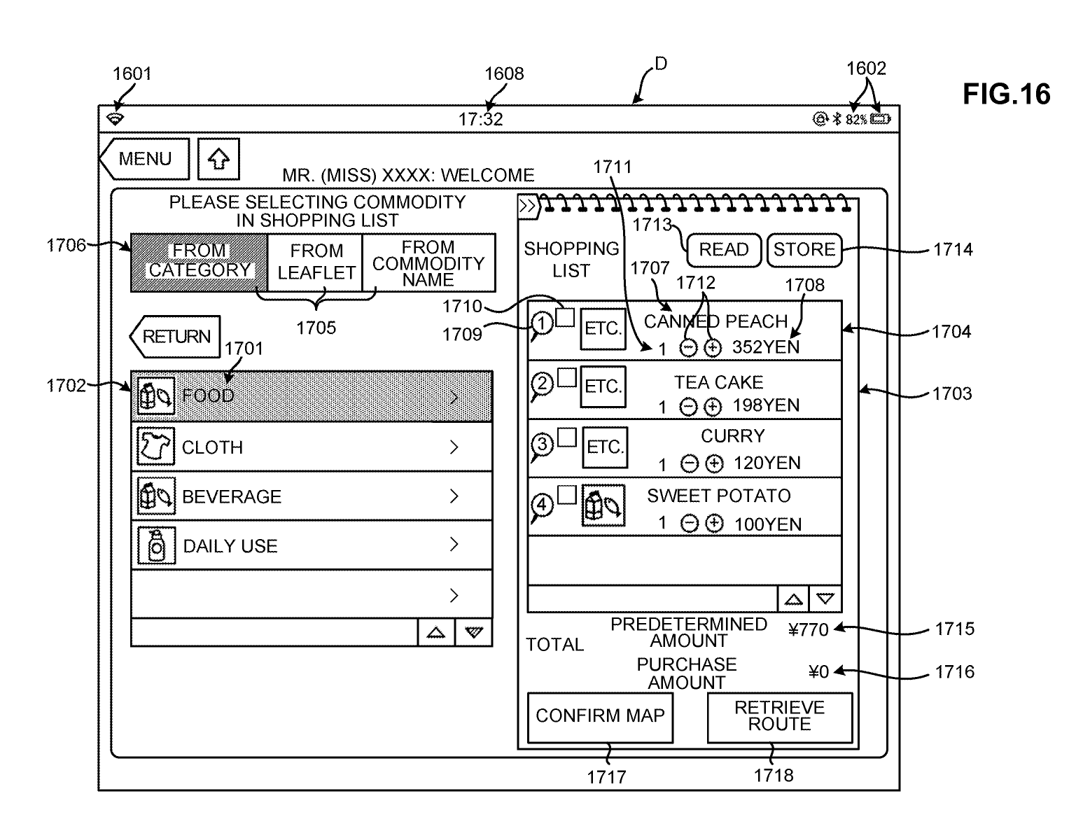

FIG. 3 is a block diagram illustrating the hardware structure of the cart terminal. The cart terminal 2 comprises a control unit 251 for performing a drive control on each component thereof. In the control unit 251, a CPU (Central Processing Unit) 252 for controlling each component of the cart terminal connects, via bus line 250, with a ROM (Read Only Memory) 253 for storing fixed data in an inerasable manner, a RAM (Random Access Memory) 254 serving as a working area of the CPU 252 to store variable data in a rewritable manner and a nonvolatile memory 258. A storage area in which a shopping list generated on the shopping list generation screen D (referring to FIG. 16) described later and the commodity shelf information read by the RFID reader/writer 220 from a shelf label (not shown) are stored is set in the RAM 254. A program executed by the CPU 252 is stored in the nonvolatile memory 258. Moreover, the control unit 251 is also connected with the LCD 213, the touch panel 214 and the scanner 215 via the bus line 259.

Further, the cart terminal 2 has a wireless communication device 261 which is connected with the control unit 251 via the bus line 259 and realizes a communication among the location detector 5, the shop server 6, the POS terminal 4 and the upper server 8 via the network 9.

FIG. 4 is a block diagram illustrating the hardware structure of the location detector. The cart terminal 5 comprises a control unit 551 for performing a drive control on each component thereof. In the control unit 551, a CPU 552 for controlling each component of the location detector connects, through the bus line 566, with a ROM 553 for storing fixed data, and a RAM 554 serving as the working area to store variable data in a rewritable manner. Moreover, the control unit 551 is further connected with an HDD (Hard Disk Drive) 555 via the bus line 556. In the HDD 555, there are stored programs and files, part or all of which are transferred to the RAM 554 to be used when the location detector 5 is started. Moreover, the control unit 551 is further connected with an LCD 510 serving as a display and a keyboard 511 serving as an input unit via the bus line 556. Moreover, the location detector 5 has a wired communication device 561 that communicates with each other device via the network 9 and is connected with the control unit 551 via the bus line 556.

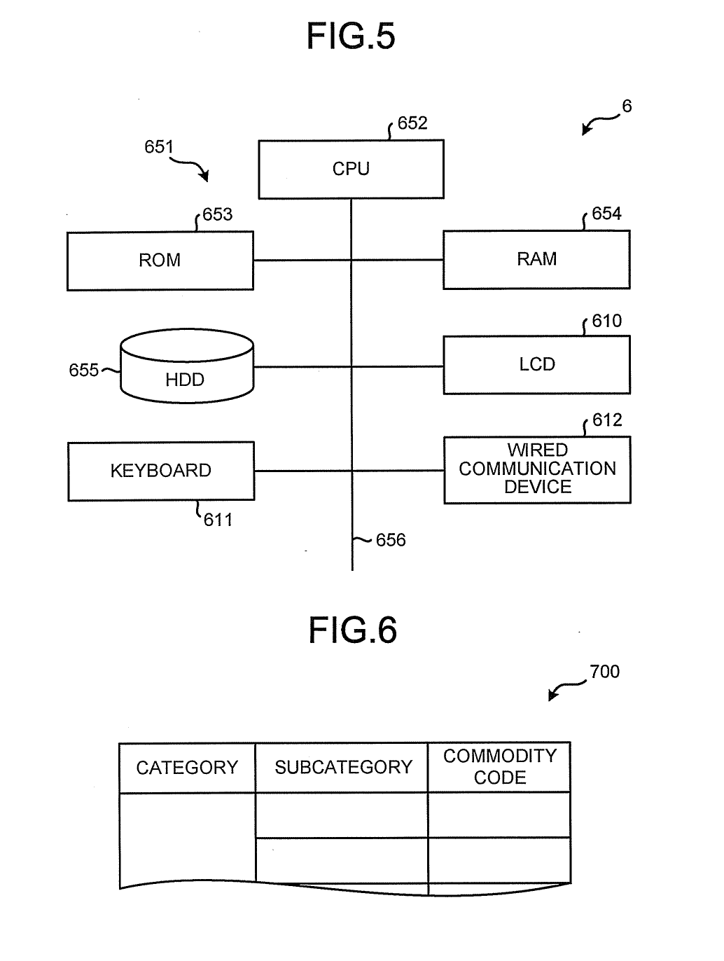

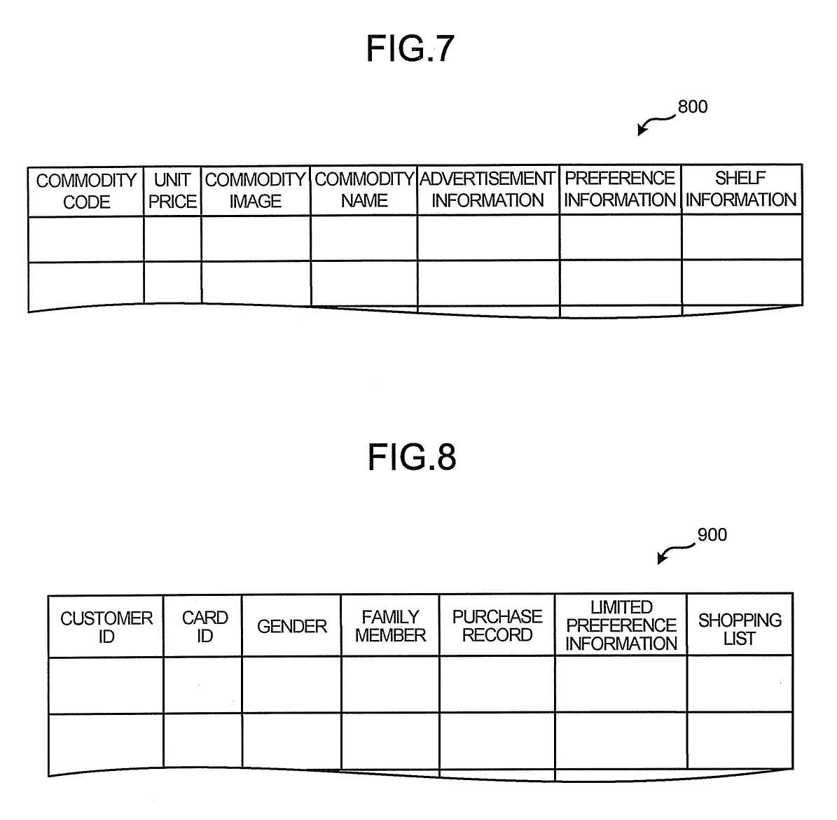

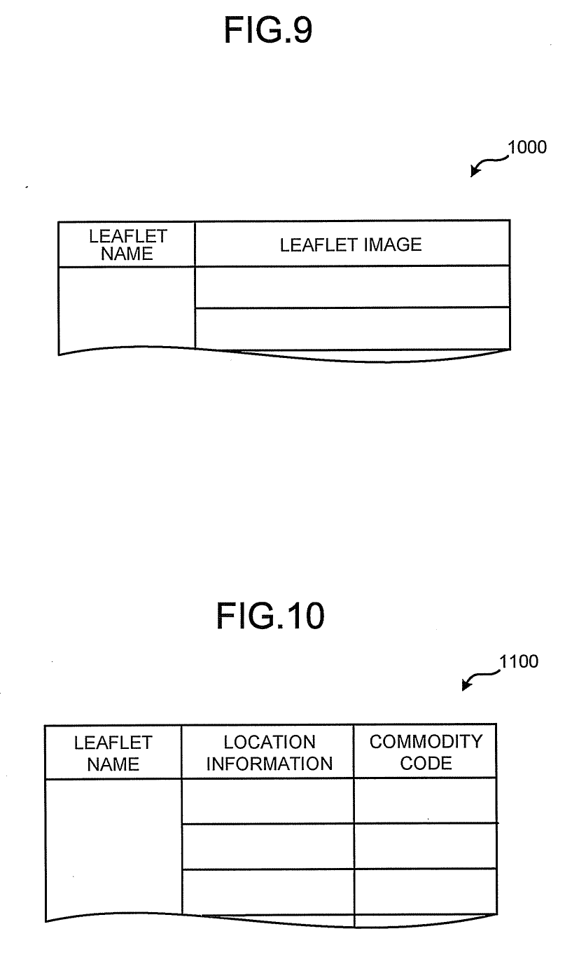

FIG. 5 is a block diagram illustrating the hardware structure of the shop server. The shop server 6 comprises a control unit 651 for performing a drive control on each component thereof. In the control unit 651, a CPU 652 for controlling each component of the shop server connects, via bus line 656, with a ROM 653 for storing fixed data, and a RAM 654 serving as a working area to store variable data in a rewritable manner. Moreover, the control unit 651 is further connected with an HDD 655 via the bus line 656. In the HDD 655, there are stored a program, a category master file 700 (referring to FIG. 6), a commodity master file 800 (referring to FIG. 7), a customer master file 900 (referring to FIG. 8), a leaflet master file 1000 (referring to FIG. 9), a leaflet data file 1100 (referring to FIG. 10) and a shop map in which the locations of the entrance and the exit of the shop, a shopping cart lending center and commodity shelves and POS terminals 4 are shown. Part or all of the program and files stored in the HDD 655 are transferred to the RAM 554 to be used when the shop server 6 is started. Moreover, the control unit 651 is further connected with an LCD 610 serving as a display and a keyboard 611 serving as an input unit via the bus line 656. Moreover, the shop server 6 has a wired communication device 612 that communicates with each other device via the network 9 and is connected with the control unit 651 via the bus line 656.

FIG. 6 is a diagram illustrating the data structure of the category master file. As shown in FIG. 6, the category master file 700 stores the top categories of commodities such as ‘Food’, ‘Cloth’, ‘Beverage, Alcohol’, ‘Kitchen ware, Daily necessities’ and ‘Gardening’, the subcategories of commodities (e.g. ‘Food’) such as ‘Dessert, Cake ’ and ‘Processed food’ in an manner that the top categories and the subcategories are associated with commodity codes for specifying each commodity.

FIG. 7 is a diagram illustrating the data structure of the commodity master file. As shown in FIG. 7, in the commodity master file 800, a unit price, a commodity image showing the form of a commodity, a commodity name, advertisement information for the promotion of the commodity, premium information on the premium offered to the customer purchasing the commodity and commodity shelf information for specifying the commodity shelf displaying the commodity are stored in a manner that they are associated with commodity codes for specifying each commodity. Moreover, in this embodiment, if a premium is offered to the customer purchasing the commodity in a given time (time sale), the premium information stored in the commodity master file 800 should further include the information of the given premium-available time.

FIG. 8 is a diagram illustrating the data structure of the customer master file. As shown in FIG. 8, in the customer master file 900, a card ID for identifying a card distributed to a customer, gender, family member of the customer and purchase record of the customer, the limited premium information on the one of the premiums enjoyable exclusively to the commodity-purchasing customers that are identified with the customer ID and a shopping list received from the cart terminal 2 are stored in a manner that they are associated with the customer ID for identifying a customer. Moreover, in this embodiment, the limited premium information includes premium information (e.g. discount amount) on the premiums offered to the customer (e.g. discount), and also the commodity code of the commodity to which the premium is applied.

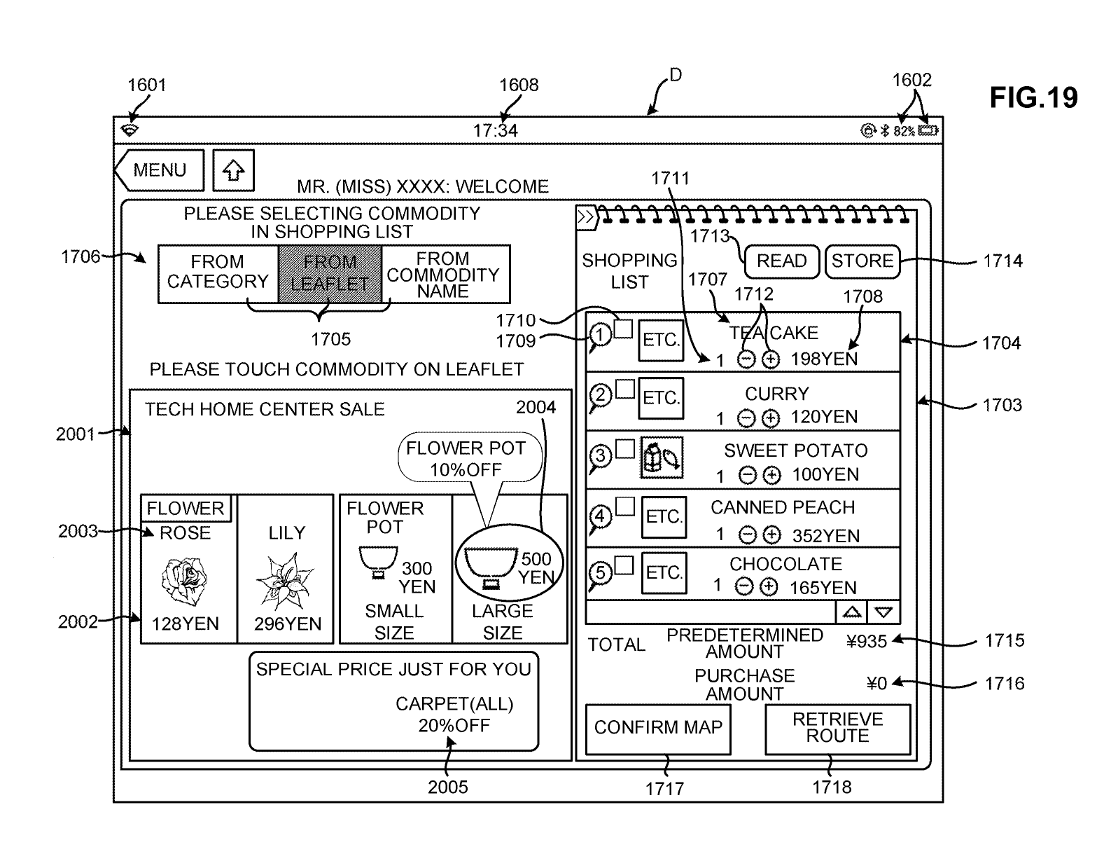

FIG. 9 is a diagram illustrating the data structure of the leaflet master file. As shown in FIG. 9, the leaflet master file 1000 stores, in an associated manner, the name of a leaflet for the advertisement of a commodity sold in the shop and a leaflet image 2001 containing a commodity information field 2002 (referring to FIG. 19) showing the commodity information 2003 (referring to FIG. 19) , such as commodity name, commodity image and unit price, of each commodity sold in the shop.

FIG. 10 is a diagram illustrating the data structure of the leaflet data file. As shown in FIG. 10, in the leaflet data file 1100, location information indicative of the location of the commodity information 2003 of each commodity filled in the commodity information field 2002 (referring to FIG. 19) and the commodity code of the commodity the commodity information 2003 (referring to FIG. 19) of which is shown are stored in a manner that they are associated with a leaflet name. Moreover, in this embodiment, the commodity information field 2002 (referring to FIG. 19) is divided into a plurality of areas for displaying the commodity information 2003 (referring to FIG. 19). Moreover, in the leaflet data file 1100, the preset numbers of the areas divided in the commodity information field 2002 (referring to FIG. 19) are stored as location information.

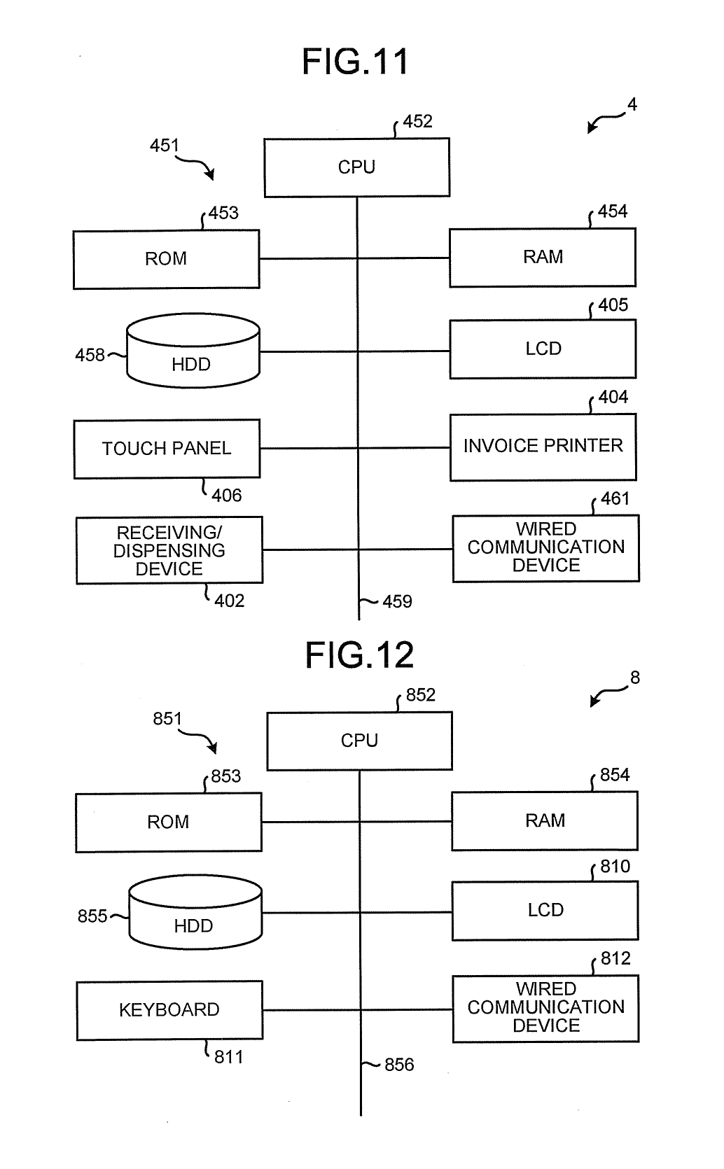

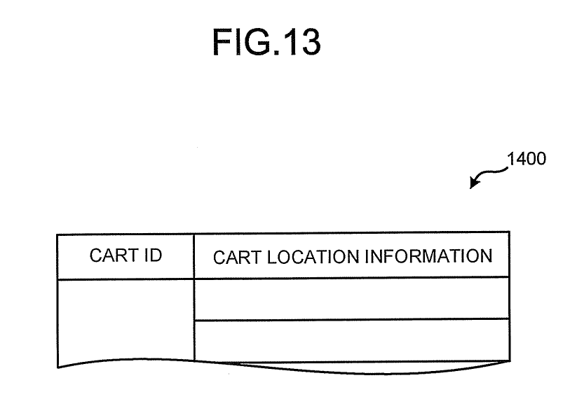

FIG. 11 is a block diagram illustrating the hardware structure of the POS terminal. The POS terminal 4 comprises a control unit 451 for performing a drive control on each component thereof. In the control unit 451, a CPU 452 for controlling each component of the POS terminal connects, through a bus line 459, with a ROM 453 for storing fixed data in an inerasable manner and a RAM 454 serving as the working area to store variable data in a rewritable manner. Moreover, the control unit 451 is further connected with an HDD 458 via the bus line 459. In the HDD 458, there is stored a program, all or part of which is loaded to the RAM 454 to be used when the POS terminal 4 is started. Moreover, the control unit 451 is connected with a depositing and dispensing device 402, an LCD 405, a touch panel 406 and a receipt printer 404 via the bus line 459. The POS terminal 4 has a wired communication device 461 that communicates with each device via the network 9 and is connected with the control unit 451 via the bus line 459. FIG. 12 is a block diagram illustrating the hardware structure of the upper server. The upper server 8 comprises a control unit 851 for performing a drive control on each component thereof. In the control unit 851, a CPU 852 for controlling each component of the upper server connects, through a bus line 856, with a ROM 853 for storing fixed data and a RAM 854 serving as the working area to store variable data in a rewritable manner. Moreover, the control unit 851 is further connected with an HDD 855 via the bus line 856. A program and a cart location information file 1400 (referring to FIG. 13) are stored in the HDD 855. Part or all of the program and the file stored in the HDD 855 are loaded to the RAM 854 to be used when the upper server 8 is started. The control unit 851 is further connected with an LCD 810 serving as a display and a keyboard 811 serving as an input unit via the bus line 856. Moreover, the upper server 8 has a wired communication device 812 that communicates with each other device via the network 9 and is connected with the control unit 851 via the bus line 856.

FIG. 13 is a diagram illustrating the data structure of the cart location information file. As shown in FIG. 13, in the cart location information file 1400, a cart ID for identifying shopping cart 3 and cart location information representing the location of a shopping cart 3 detected by the location detector 5 are stored in association with each other.

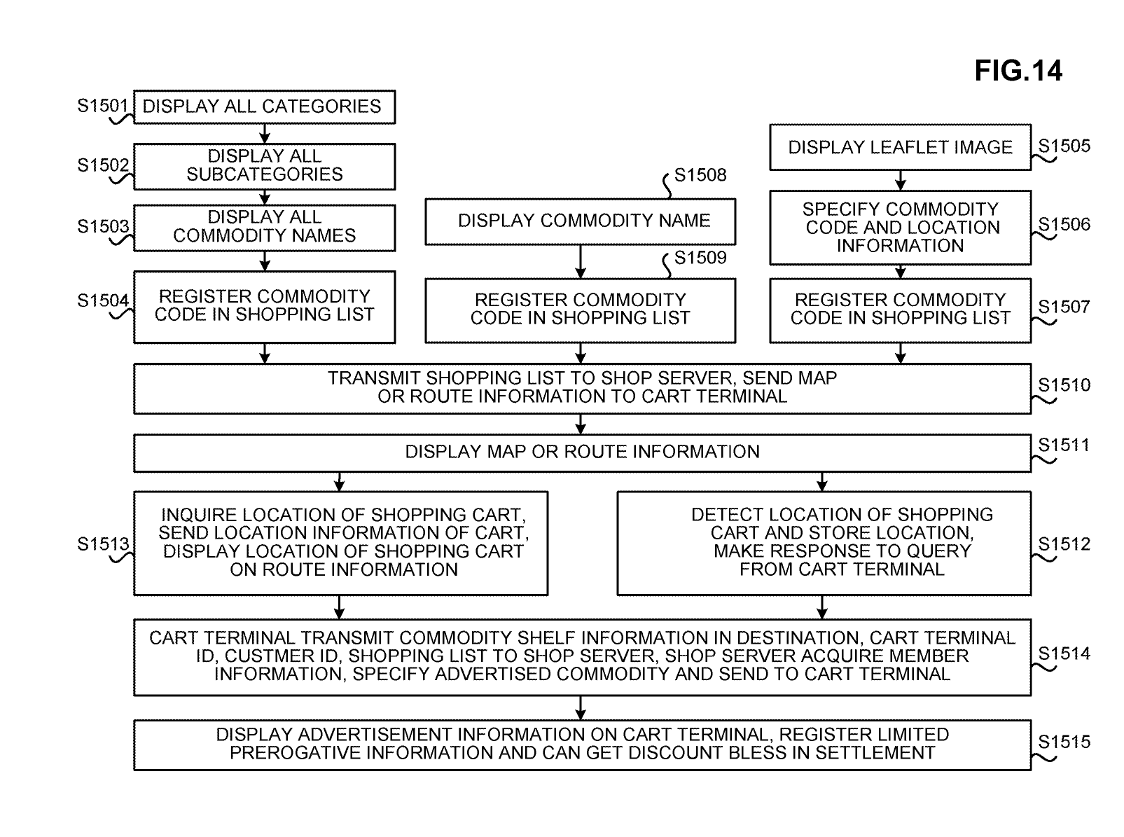

Next, the flow of a processing starting from the borrowing of a shopping cart 3 and ending to the settlement of commodities in the checkout system according to the embodiment is described below with reference to FIG. 14.

FIG. 14 is a flowchart of a processing starting from the borrowing a shopping cart and ending to the settlement of commodities in the checkout system according to the embodiment.

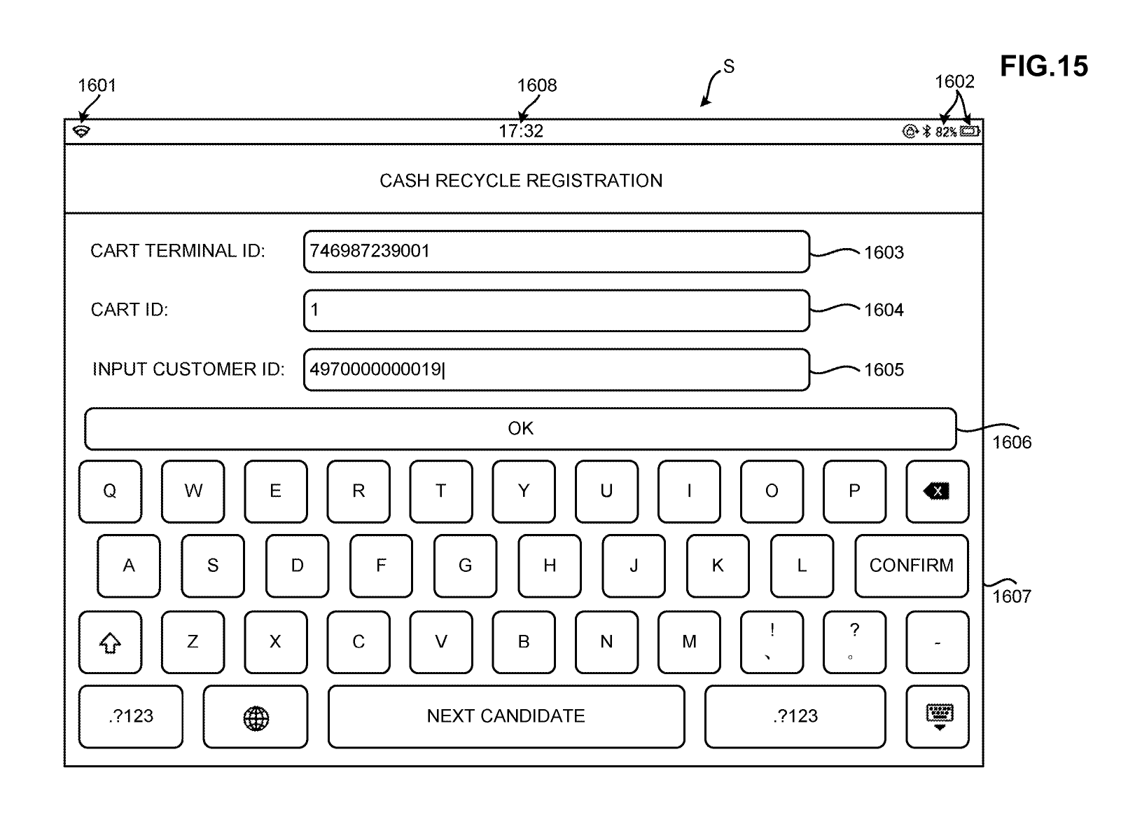

When desiring to borrow a shopping cart 3 at the entrance of the shop, the customer performs the lending registration of a shopping cart 3 on the lending registration screen S (referring to FIG. 15) displayed on the LCD 213 of the cart terminal 2 installed on the shopping cart 3. FIG. 15 is a diagram illustrating an example of a lending registration screen for the lending registration of a shopping cart. When a shopping cart is lent at the entrance of the shop and then the touch on the touch panel 214 of the cart terminal 2 by the customer is detected, the control unit 251 of the cart terminal 2 displays the lending registration screen S for the lending registration of a shopping cart 3.

The lending registration screen S displays a communication state indication 1601 indicative of the wireless communication state of the wireless communication device of the cart terminal 2, a current time 1608, a remaining power indication 1602 indicative of the remaining power of the battery of the cart terminal 2, a cart terminal ID field 1603 for the input of a cart terminal ID identifying a specific cart terminal 2, and a cart ID field 1604 for the input of the cart ID identifying a specific shopping cart 3 provided with the cart terminal 2. The lending registration screen 5 also displays a customer ID field 1605 for the input of a customer ID, a button 1606 for lending registration of a shopping cart 3 by the customer identified by the customer ID input in the customer ID field 1605 and a software keyboard 1607 for the input of various kinds of information in the cart terminal ID field 1603, the cart ID field 1604 and the customer ID field 1605.

When a cart terminal ID, a cart ID and a customer ID are input on the lending registration screen S and the button 1606 is pressed down, the control unit 251 of the cart terminal 2 displays a shopping list generation screen D (referring to FIG. 16) in which a list of the top categories from the category master file 700 of the shop server 6 are all displayed (Act S1501). In addition, the control unit 251 of the cart terminal 2 stores the customer ID input in the RAM 254 of the cart terminal 2 and registers the customer identified by the customer ID input as a customer operating the shopping cart 3.

FIG. 16 is a diagram illustrating an example of the shopping list generation screen showing a list of categories. On the shopping list generation screen D, there is displayed a category field 1702 in which all the top categories 1701 (e.g. Food’, ‘Cloth’, ‘Beverage, Alcohol’, ‘Kitchen ware, Daily necessities’ and ‘Gardening’) of the category master file 700 of the shop server 6 are displayed, a shopping list field 1703 in which a list of commodities 1704 represented by the commodity codes contained in a shopping list stored in the RAM 254 of the cart terminal 2 is displayed, and a selection method field 1706 in which selection buttons for selecting a commodity selection method (select ‘from Category’, select ‘from Leaflet’, or select ‘from Commodity name’) for selecting commodities from the list of commodities 1704 are displayed.

In the list of commodities 1704 in the shopping list field 1703, there is displayed the commodity name 1707 and the unit price 1708 represented by a commodity code contained in a shopping list stored in the RAM 254 of the cart terminal 2, a number of commodities 1711 purchased, a change button 1712 for changing the number of a purchased commodity, a balloon 1709 showing the purchase order of commodities, and a check field 1710 for checking whether or not commodities are housed in the storage unit 202.

Further, a read-in button 1713 for requesting the reading of a shopping list from the customer master file 900 of the shop server 6 is displayed in the shopping list field 1703. Further, a storage button 1714 for requesting the registration of a shopping list stored in the RAM 254 of the cart terminal 2 in the customer master file 900 of the shop server 6 is displayed in the shopping list field 1703.

Further, in the shopping list field 1703, there is displayed a summed amount, that is, an expected amount 1705, indicating the total purchase amount of the commodities the commodity names of which are displayed in the list of commodities 1704, a summed amount, that is a purchase amount 1706, indicating the total purchase amount of the commodities the housing of which in the accommodation unit 202 is checked by the check field 1710 of the list of commodities 1704, a map confirmation button 1717 for requesting the display of the map information of the shelves on which the commodities are displayed that are represented by the commodity codes registered in the shopping list stored in the RAM 254 of the cart terminal 2, and a rout retrieval button 1718 for requesting retrieval of a route for purchasing the commodities represented by the commodity codes registered in the shopping list stored in the RAM 254.

Further, the list 1704 of commodities in the shopping list field 1703 is empty if no commodity codes are registered in the shopping list stored in the RAM 254 of the cart terminal 2. However, if the customer pre-stores, using a PC (Personal Computer) installed in the house of the customer or a cell phone, the commodity codes of the commodities to be purchased in the shopping list of the customer master file 900 of the shop server 6, the control unit 251 reads the shopping list of the customer master file 900 from the commodity master file 800 of the shop server 6 and stores the read shopping list in the RAM 254. Then, the control unit 251 displays, in the shopping list field 1703, the commodity names 1707 and the unit prices 1708 of the commodities represented by the commodity codes registered in the shopping list stored in the RAM 254.

Moreover, if no commodity purchase route is retrieved in the shop server 6, the control unit 251 displays, in the shopping list field 1703, the balloon 1709 which displays an order of commodity code registration recorded in the shopping list stored in the RAM 254 of the cart terminal 2 as an order of purchasing commodity.

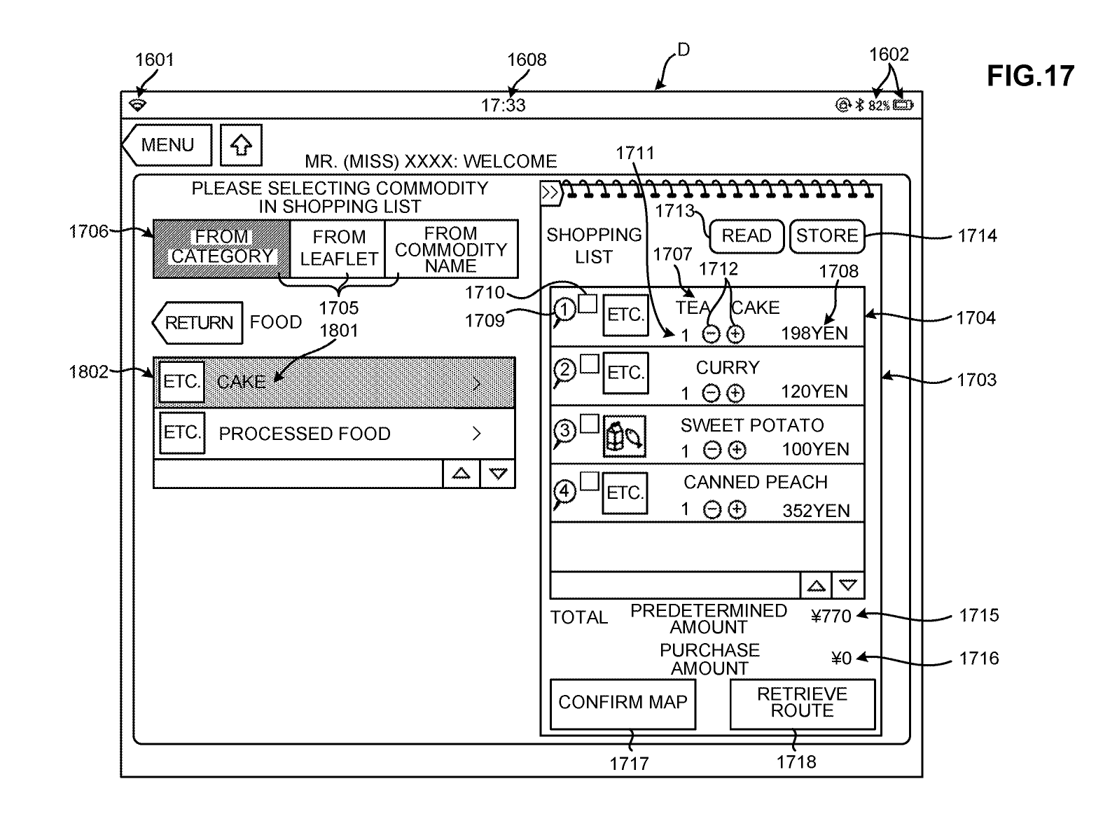

Returning to FIG. 14, the control unit 251 of the cart terminal 2 displays a shopping list generation screen S (referring to FIG. 17) on which subcategories classified in the lower class of a selected category within the subcategories stored in the category master file 700 of the shop server 6 are displayed when a desired category 1701 is selected from the categories displayed in the category field 1702 of the shopping list generation screen D shown in FIG. 16 (Act S1502).

FIG. 17 is a diagram illustrating an example of a shopping list generation screen showing all subcategories. If a category 1701 (e.g. ‘Food’) is selected on the shopping list generation screen D shown in FIG. 16, then, instead of the category field 1702, a subcategory field 1802 in which all the subcategories (e.g. ‘Snack food’, ‘Cake’, ‘Processed food’) 1801 classified in the lower class of the selected category 1701 (e.g. ‘Food’) within the subcategories stored in the category master file 700 of the shop server 6 are displayed is displayed.

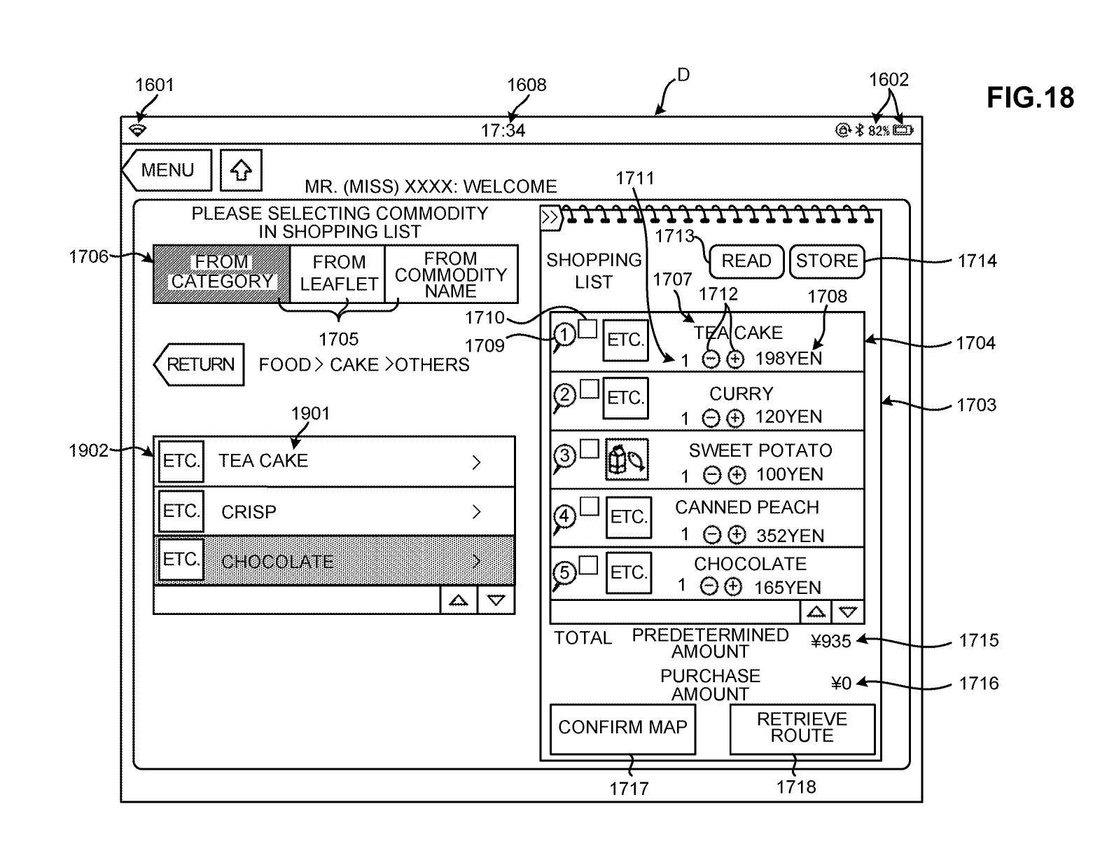

Returning to FIG. 14, when a desired subcategory 1801 is selected from the subcategories displayed in the subcategory field 1802 of the shopping list generation screen D shown in FIG. 17, the control unit 251 of the cart terminal 2 selects the commodity code classified in the selected subcategory 1801 from the commodity codes stored in the category master file 700 of the shop server 6. Then, the control unit 251 displays a shopping list generation screen D (referring to FIG. 18) on which the commodity names corresponding to the selected commodity code within the commodity names stored in the commodity master file 800 of the shop server 6 are displayed is displayed (Act S1503).

FIG. 18 is a diagram illustrating an example of a shopping list generation screen showing all commodity names. If a desired subcategory 1801 (e.g. ‘Snack food’, ‘Cake’) is selected on the shopping list generation screen D shown in FIG. 17, then, in stead of the subcategory field 1802, a commodity selection field 1902 on which all the commodity names (e.g. ‘Fried Sugar cookie’, ‘Sesame-Stick’, ‘Sponge Cake’) associated with the commodity codes classified in the selected subcategory (e.g., ‘Snack Food’, ‘Cake’) within the commodity names stored in the commodity master file 800 of the shop server 6 are displayed is displayed.

Returning to FIG. 14, when a desired commodity name 1901 from the commodity names 1901 displayed in the commodity selection field 1902 of the shopping list generation screen D shown in FIG. 18 is selected, the control unit 251 of the cart terminal 2 acquires a commodity code corresponding to the selected commodity name 1901 from the commodity master file 800 of the shop server 6. Then, the control unit 251 registers the acquired commodity code in the shopping list stored in the RAM 254 of the cart terminal 2 (Act S1504). In addition, the control unit 251 displays the commodity name 1707 and the unit price 1708 of the commodity specified by the acquired commodity code on the list 1704 of commodities in the shopping list field 1703.

When the selection button (select ‘from leaflet’) 1705 for selecting commodities from leaflet within the selection buttons displayed in the selection method field 1706 of the shopping list generation screen ID is pressed down, the control unit 251 of the cart terminal 2 acquires a leaflet name and a leaflet image corresponding to the leaflet name. Then, the control unit 251 displays a shopping list generation screen ID (referring to FIG. 19) on which the acquired leaflet image is displayed (Act S1505).

FIG. 19 is a diagram illustrating an example of a shopping list generation screen showing a leaflet image. When the selection button (select ‘from Leaflet’) 1705 displayed in the selection method field 1706 of the shopping list generation screen D shown in FIG. 18 is pressed down, the control unit 251 of the cart terminal 2 acquires a leaflet name and a leaflet image associated with the leaflet name from the leaflet master file 1000 stored in the HDD 655 of the shop server 6. Then, the leaflet image 2001 acquired from the shop server 6 is displayed on the shopping list generation screen D instead of the commodity selection field 1902. The leaflet image 2001 includes a commodity information field 2002 in which commodity names, commodity images and unit prices of the commodities sold in the shop are displayed.

When displaying the shopping list generation image D containing the leaflet image 2001, the control unit 251 of the cart terminal 2 acquires, from the customer master file 900 of the shop server 6, limited premium information associated with the customer ID input on the lending registration screen S. Further, the control unit 251 acquires location information associated with the commodity code coincident with the commodity code contained in the acquired limited premium information from the leaflet data file 1100 stored in the HDD 655 of the shop server 6. Then, the control unit 251 applies a round mark 2004 on the commodity information 2003 at the location indicated with the acquired location information and displays the limited premium information 2005 (e.g. discount amount) nearby the commodity information 2003.

In this embodiment, a round mark 2004 is applied on the commodity information 2003, however, it is not limited to this, as long as the commodity information 2003 of the commodity to which the premium indicated in the limited premium information is applied is displayed in a form different from those of other commodity information. For instance, it may be available to make the display area of the commodity on which the premium indicated in the limited premium information is applied blink or display it in a color different from those of other commodity information 2003.

Moreover, in the case where all the commodity codes contained in the limited premium information are different from those stored in the leaflet data file 1100, the control unit 251 of the cart terminal 2 sets, in the leaflet image 2001, a best-buy commodity field 2006 in which the limited premium information 2005 is displayed. Moreover, in this embodiment, the best-buy commodity field 2006 is set in the case where the commodity codes contained in the limited premium information are not coincident with those stored in the leaflet data file 1100, however, it may be available that the best-buy commodity field 2006 is also set regardless of whether or not the commodity codes contained in the limited premium information are coincident with those stored in the leaflet data file 1100.

The control unit 251 of the cart terminal 2 may further acquire premium information containing the current time information and display the acquired premium information (that is, the premium which is applied to the customers who purchase commodity within a given time) in the best-buy commodity field 2006.

Returning to FIG. 14, when a desired commodity information 2003 is selected from the commodity information field 2002, the control unit 251 of the cart terminal 2 specifies from the leaflet data file 110 a commodity code associated with the location information on the area where the selected commodity information 2003 is displayed (Act S1506). Then, the control unit 251 registers the specified commodity code in the shopping list stored in the RAM 254 of the cart terminal 2 (Act S1507). In addition, the control unit 251 displays the commodity name 1707 and the unit price 1708 of the commodity specified by the specified commodity code in the list 1704 of commodities in the shopping list field 1703.

In addition, when the limited premium information 2005 displayed on the shopping list generation screen D is selected, the control unit 251 of the cart terminal 2 registers the selected limited premium information together with the commodity code in the shopping list stored in the RAM 254 of the cart terminal 2.

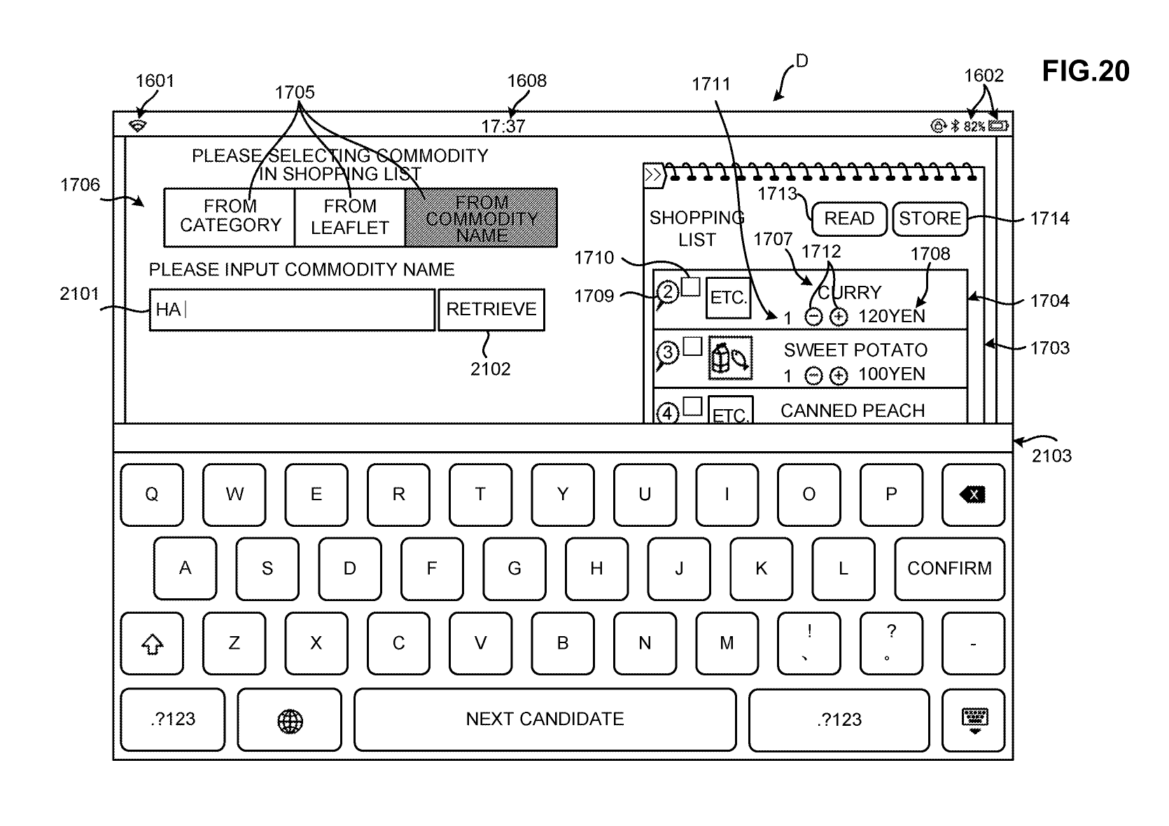

When the selection button (select ‘from commodity name’) 1705 for selecting commodity from the commodity name displayed in the selection method field 1706 of the shopping list generation screen D is pressed down, the control unit 251 of the cart terminal 2 displays a shopping list generation screen D (referring to FIG. 20) on which a commodity name input field for the input of a commodity name is displayed.

FIG. 20 is a diagram illustrating an example of a shopping list generation screen showing a commodity name input field. When the selection button 1705 (select ‘from commodity name’) displayed in the selection method field 1706 of the shopping list generation screen D shown in FIG. 18 is pressed down, a commodity name input field 2101 for the input of a commodity name, a retrieval button 2102 for requesting retrieval of a commodity name containing letters string input in the commodity name input field 2101 and a software keyboard 2103 for the input of letters string in the commodity name input field 2101 are displayed on the shopping list generation screen D instead of the commodity selection field 1902.

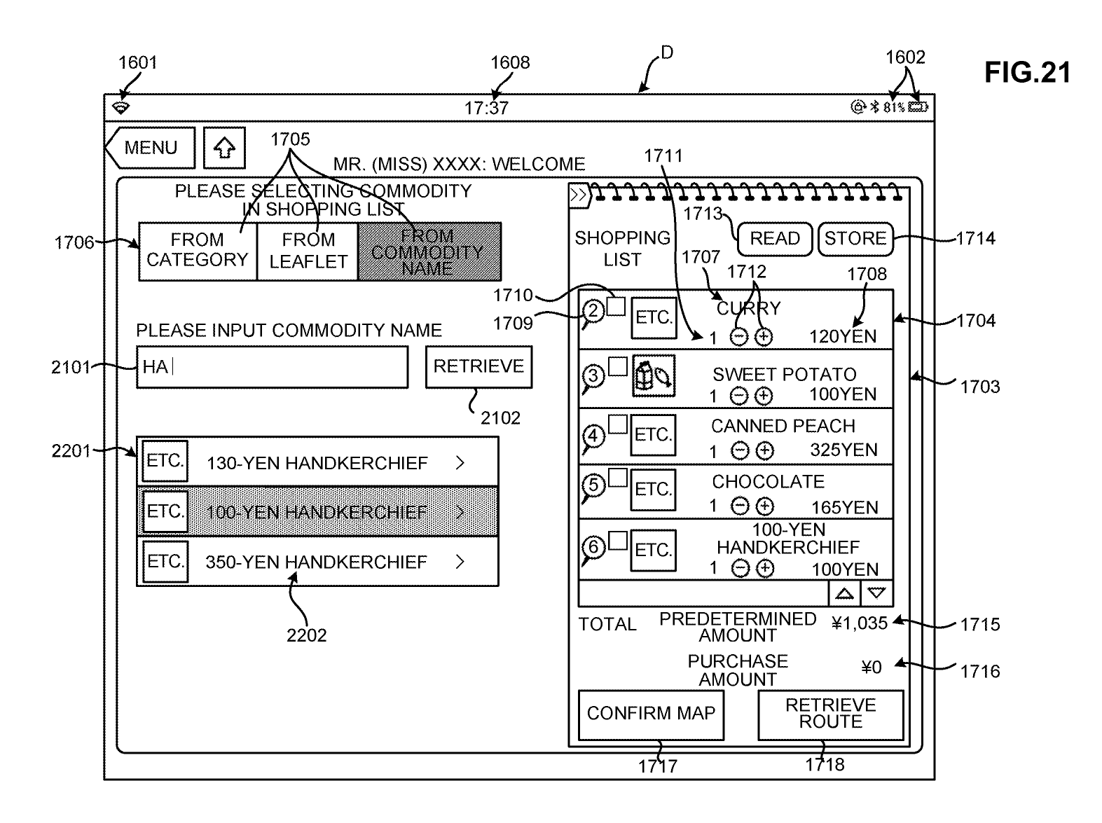

Returning to FIG. 14, when letters string is input in the commodity name input field 2102 and the retrieval button 2102 is pressed down, the control unit 251 of the cart terminal 2 retrieves a commodity name containing the input letters string in the commodity master file 800 of the shop server 6. In addition, the control unit 251 displays a shopping list generation screen D (referring to FIG. 21) on which all the retrieved commodity names is displayed (Act S1508).

FIG. 21 is a diagram illustrating an example of a shopping list generation screen showing all the retrieved commodity names. When the retrieval button 2102 on the shopping list generation screen D shown in FIG. 20 is pressed down, a commodity selection field 2201 in which all the commodity names retrieved from the commodity master file 800 are displayed is displayed on the shopping list generation screen D.

Returning to FIG. 14, when a desired commodity name 2202 is selected from the commodity names 2202 displayed in the commodity selection field 2202 of the shopping list generation screen D shown in FIG. 21, the control unit 251 of the cart terminal 2 acquires a commodity code associated with the selected commodity name 2202 from the commodity master file 800 of the shop server 6. Then, the control unit 251 registers the acquired commodity code in the shopping list stored in the RAM 254 of the cart terminal 2 (Act S1509). In addition, the control unit 251 displays the commodity name 1707 and the unit price 1708 of the commodity specified by the acquired commodity code in the commodity list 1704 in the shopping list field 1703.

Returning to FIG. 14, when the map confirmation button 1717 or the route retrieval button 1718 displayed on the shopping list generation screen ID is pressed down, the control unit 251 of the cart terminal 2 transfers the shopping list stored in the RAM 254 to the shop server 6 (Act S1510).

When the map confirmation button 1717 is pressed down, the control unit 651 of the shop server 6 reads out, from the commodity master file 800 stored in the HDD 655, commodity shelf information associated with the commodity code registered in the shopping list received from the cart terminal 2. Then, the control unit 651 generates, on the shop map stored in the HDD 655, map information showing the arrangement of commodity shelves indicated with the commodity shelf information read out, and then sends the generated map information to the cart terminal 2 (Act S1510).

When the route retrieval button 1718 is pressed down, the control unit 651 of the shop server 6 reads out, from the commodity master file 800 stored in the HDD 655, commodity shelf information associated with the commodity code registered in the shopping list received from the cart terminal 2. Then, the control unit 651 displays, on the shop map stored in the HDD 655, the commodity shelf shown in the commodity shelf information read out and generates route information showing a route passing the commodity shelf shown in the commodity shelf information read out. Then the control unit 651 sends the generated route information to the cart terminal 2 (Act S1510).

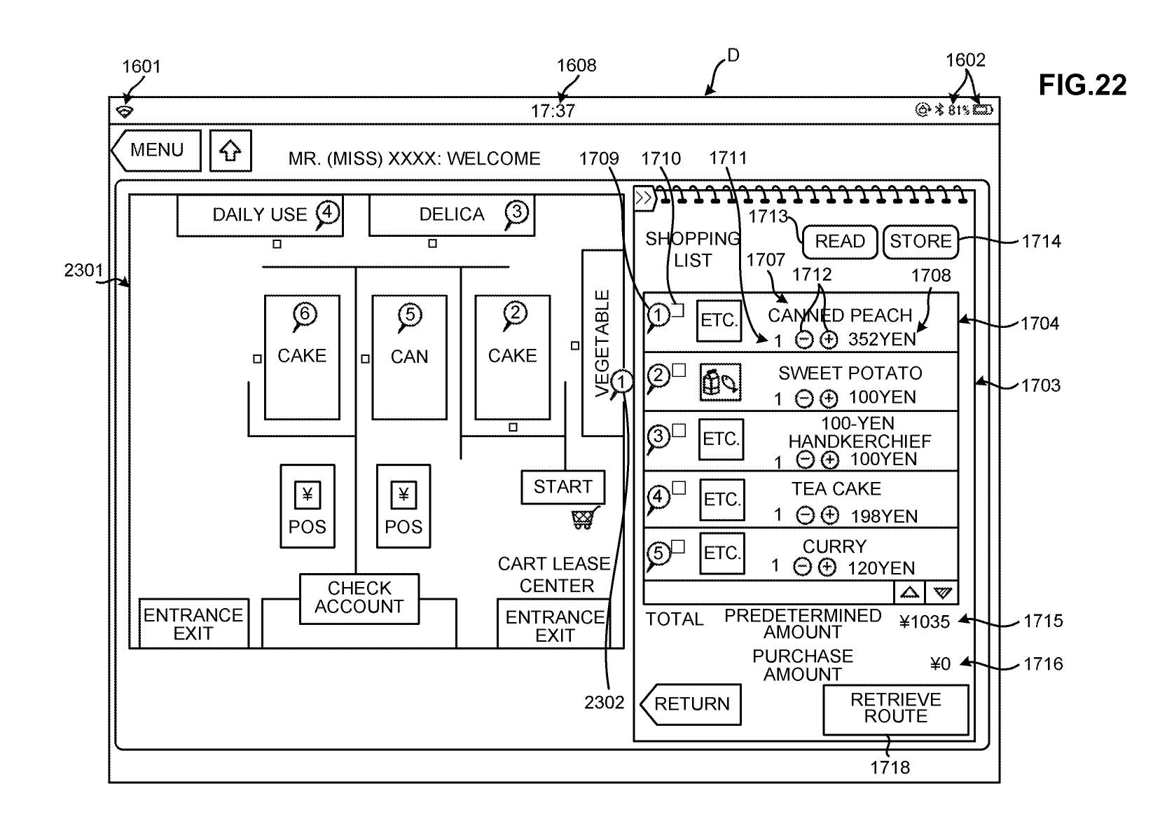

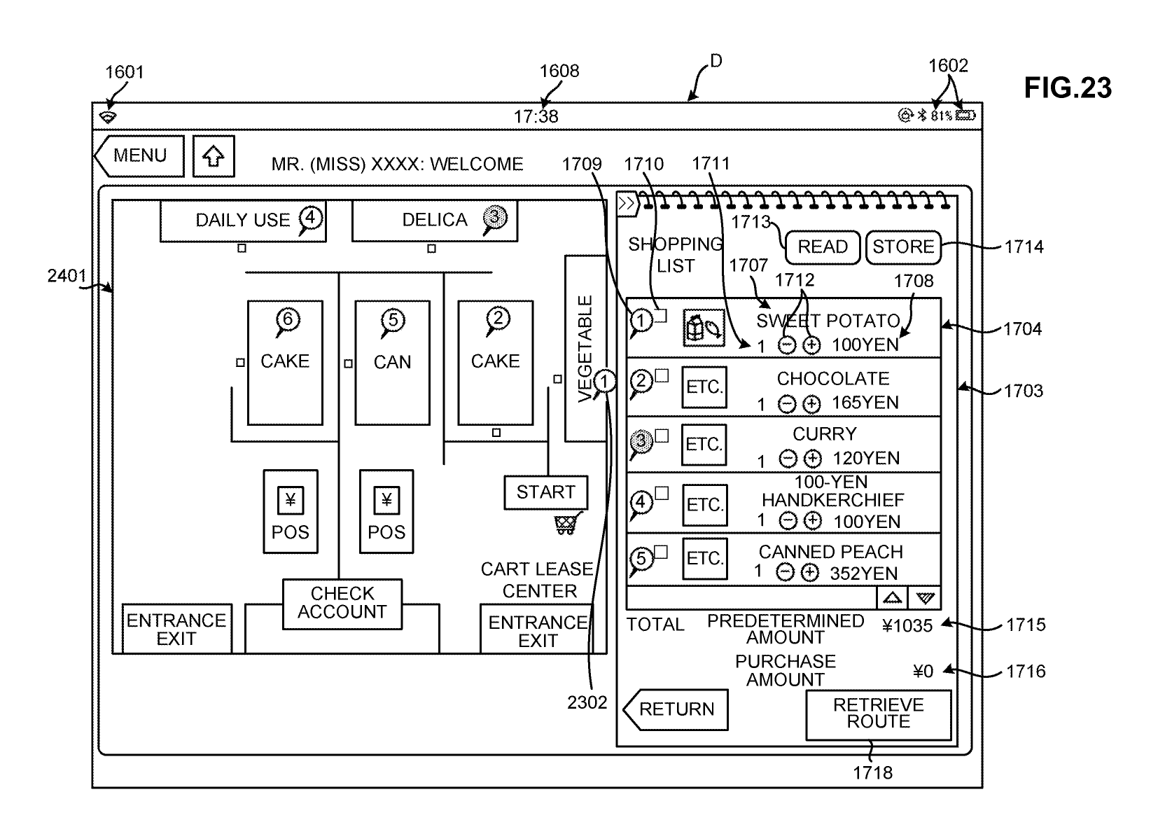

The control unit 251 of the cart terminal 2 displays the shopping list generation screen D (referring to FIG. 22 and FIG. 23) on which the map information or the route information received from the shop server 6 is displayed (Act S1511).

FIG. 22 is a diagram illustrating an example of a shopping list generation screen showing map information. When the map confirmation button 1717 on the shopping list generation screen D shown in FIG. 2 is pressed down, the map information 2301 received from the shop server 6 is shown, instead of the commodity selection field 2201, on the shopping list generation screen D. In the map information 2301, a balloon 2302 which indicates the order of purchasing the commodities specified with the commodity codes registered in the shopping list is applied on the commodity shelf on which the commodities specified by the commodity codes registered in the shopping list are displayed. Therefore, the map information 2301 represents the shelves on which the commodities specified by the commodity codes registered in the shopping list are displayed. Further, when no route information is generated in the shop server 6, the order in which commodity codes are registered in the shopping list is displayed on the balloon 2302. Further, the location 2303 of the shopping cart 3 detected by the location detector 5 and managed by the upper server 8 is displayed in the map information 2301.

FIG. 23 is a diagram illustrating an example of a shopping list generation screen showing route information. When the route retrieval button 1718 on the shopping list generation screen D shown in FIG. 22 is pressed down, the route information 2401 received from the shop server 6 is shown on the shopping list generation screen ID instead of the map information 2301. In the rout information 2401, in addition to the display of balloons 2302 and the location 2303 of the shopping cart 3, the rout passing by the commodity shelves on which balloons are applied is displayed. Further, in the order shown on the balloon 2302, the order of the commodity shelves passed by according to the route 2402 is displayed.

Returning to FIG. 14, without being synchronous with the processing in the cart terminal 2, the control unit 551 of the location detector 5 reads the commodity shelf information that is read by the RFID reader/writer 220 of the cart terminal 2 and stored in the RAM 254 and detects the commodity shelf shown by the read commodity shelf information as the location of the shopping cart 3 in the shop (Act S1512). Then, the control unit 551 stores the detected cart location information representing the location of the shopping cart 3 in the cart location information file 1400 of the upper server 6 in association with the cart terminal ID input on the lending registration screen S. Then, the control unit 851 of the upper server 8 returns the cart location information representing the location of the cart terminal 2 in response to a query from the cart terminal 2.

Besides, in this embodiment, the control unit 551 of the location detector 5 detects the commodity shelf indicated in the commodity shelf information read by the RFID reader/writer 220 of the cart terminal 2 as the location of the shopping cart 3, however, it should be appreciated that the present invention is not limited to this. For instance, the location detector 5 may further detect the location of the shopping cart 3 or the cart terminal 2, using a short distance communication such as indoor GPS or WiFi.

The control unit 251 of the cart terminal 2 sends the cart terminal ID input through the lending registration screen S periodically during the display period of the route information 2401 on the shopping list generation screen D so as to query the location of the shopping cart 3 (Act S1513). The control unit 851 of the upper server 8 reads out cart location information, stored in the cart location information file 1400, which is associated with the cart terminal ID sent by the cart terminal 2 and sends the cart location information to the cart terminal 2 (Act S1513). The control unit 251 of the cart terminal 2 displays the location shown in the cart location information received from the upper server 8 in the route information 2401 of the shopping list generation screen D (Act S1513) as the location 2303 of the shopping cart 3.

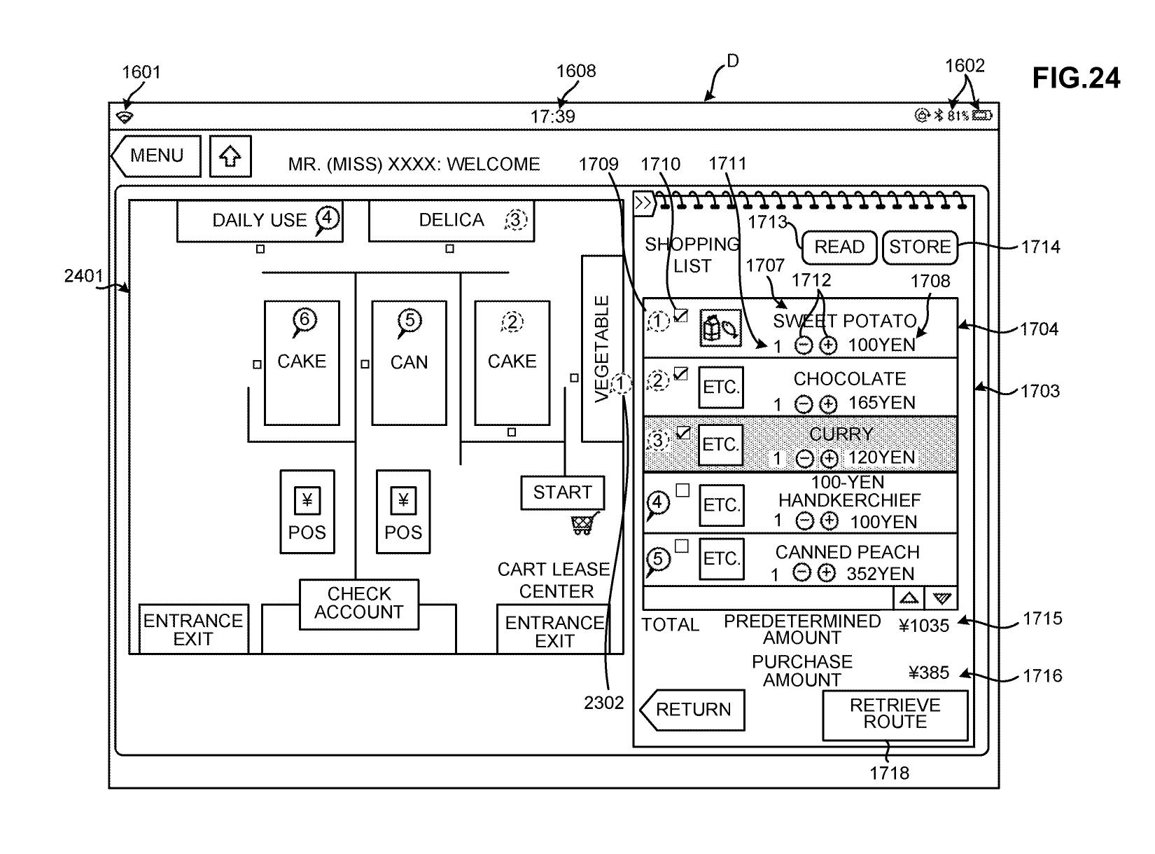

FIG. 24 is a diagram illustrating an example of a shopping list generation screen showing route information. When cart location information is received from the upper server 8, the control unit 251 of the cart terminal 2 moves the location 2303 of the shopping cart 3 to the location (e.g. the commodity shelf on which delicatessen are displayed) indicated in the received cart location information. Further, the control unit 251 distinguishes the route 2402 to the location 2303 of the moved shopping cart 3 from other routes 2402 by representing the former with a dotted line or displaying the former in gray out. Further, the control unit 251 distinguishes the balloon 2302 displayed on the commodity shelf passed in the route to the location 2303 of the moved shopping cart 3 from other balloons 2302 by representing the former with a dotted line or displaying the former in gray out.

Returning to FIG. 14, when displaying the location 2401 of the shopping cart 3 in the route information 2401 on the shopping list generation screen ID, the control unit 251 of the cart terminal 2 transmits the commodity shelf information specifying the commodity shelf where the location 2401 is displayed, the cart terminal ID and the customer ID input on the lending registration screen S and the shopping list stored in the RAM 254 to the shop server 6 (Act S1514). The control unit 651 of the shop server 6 acquires member information such as gender, family member and purchase record of the customer and limited premium information from the customer master file 900, using the commodity shelf information, the cart terminal ID, the customer ID and the shopping list received from the cart terminal 2. Then, the control unit 651 specifies a commodity to be advertised based on the member information (Act S1514). Subsequently, the control unit 651 of the shop server 6 reads out advertisement information associated with the commodity code representing the specified commodity from the commodity master file 800, and sends the cart terminal 2 the advertisement information read and the limited premium information acquired from the customer master file 900 (Act S1514).

The control unit 251 of the cart terminal 2 displays the advertisement information and the limited premium information received from the shop server 6 during the display period of the shopping list generation screen D shown in FIG. 24 (that is, the display period of the shopping list generation screen D on which the route information 2401 is displayed) (Act S1515). In addition, when the displayed limited premium information is selected (specified by touching), the control unit 251 of the cart terminal 2 registers the selected limited premium information in the shopping list of the RAM 254 so that the customer can enjoy the premium (e.g. discount) indicated in the limited prerogative premium information when settling an account at the POS terminal 4.

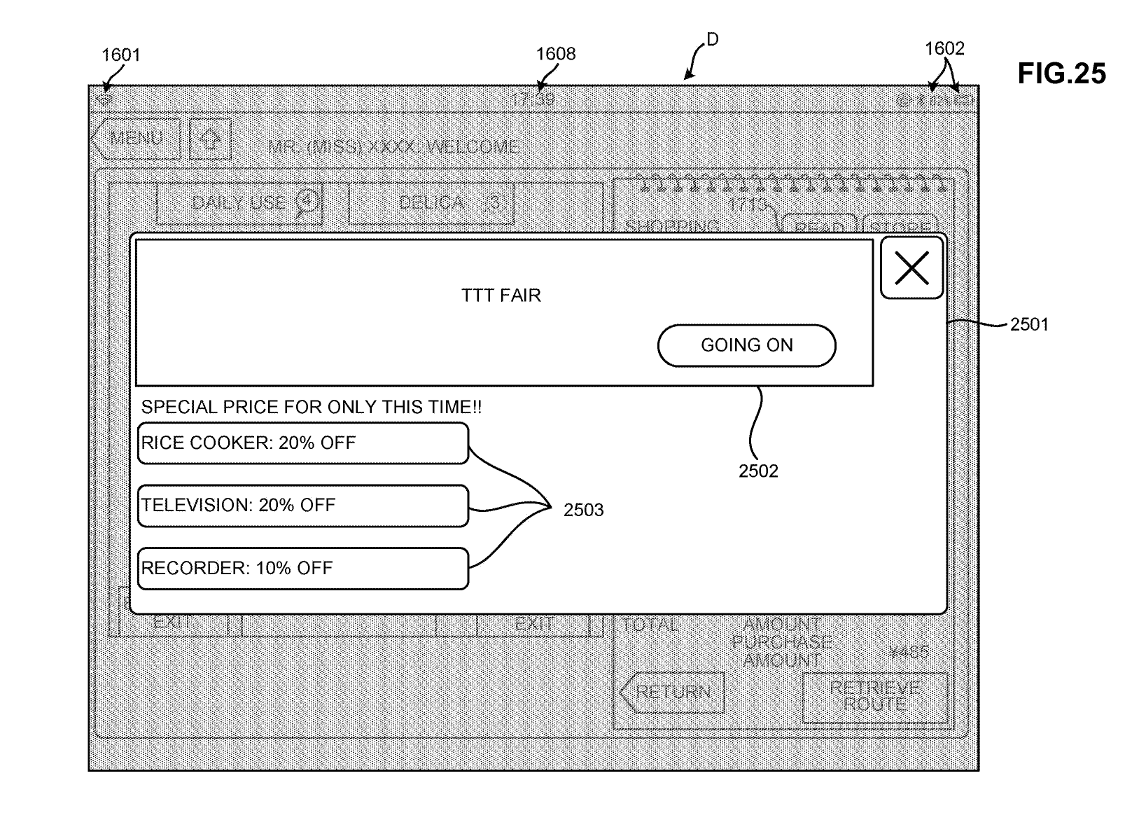

FIG. 25 is a diagram illustrating an example of a shopping list generation screen on which advertisement information and limited premium information pop up display is displayed. When advertisement information and limited premium information are received from the shop server 6, the control unit 251 of the cart terminal 2 enables a screen 2501 showing the advertisement information 2502 and the limited premium information 2503 to pop up on the shopping list generation screen D during the display period of the shopping list generation screen D shown in FIG. 24. The customer can register the limited premium information in the shopping list stored in the RAM 254 by selecting (touching) the limited premium information 2503 displayed on the screen 2501.

In this way, according to the shopping cart 3 of in this embodiment, the shopping cart 3 comprises a cart 201a conveying commodities and an LCD 213 that is installed on the cart 201a as a display, registers a customer operating the cart 201a and displays, on the LCD 213, the premium info nation showing premium applied to the registered customers within the premiums enjoyable to the commodity-purchasing customers. Thus, since the premium information relating to the premium offered only to the customers who come to the shop is displayed on the LCD 213, it can be possible to increase customers who come to the shop.

Further, in this embodiment, the program executed in the cart terminal 2 is preprogrammed in the ROM 253, however, the present invention is not limited to this, the program can also be stored in computer-readable storage mediums such as CD-ROM, floppy disk (FD), CD-R and digital versatile disk (DVD) as an installable or executable file and provided by the computer-readable storage mediums.

Moreover, the program executed in the cart terminal 2 of this embodiment can also be stored in a computer connected with a network such as the Internet and loaded from the network to be used. In addition, the program executed in the cart terminal 2 of this embodiment can also be provided or published by networks such as the Internet.

The program executed in the cart terminal 2 of this embodiment can also be formed as a module including the control unit 251 and read and executed by the actual hardware CPU 252 from the ROM 253, thereby loading the control unit 251 to a main memory device and generating the control unit 251 on the main memory device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shopping cart, comprising:
a cart configured to convey commodities;
a display mounted on the cart;
a registration unit configured to register a customer who operates the cart; and
a display control unit configured to display on the display premium information indicating premium which is offered to the customer registered by the registration unit within the premiums offered to customers when purchasing commodity.

2. The shopping cart according to claim 1, wherein
the display control unit displays on the display premium information which is offered to the customer when purchasing commodity within a given time.

3. The shopping cart according to claim 1, wherein
the display control unit displays on the display premium information together with an advertisement information of commodity.

4. The shopping cart according to claim 2, wherein
the display control unit displays on the display the prerogative premium information together with an advertisement information of commodity.

5. The shopping cart according to claim 3, wherein
the display control unit displays on the display a commodity which is offered to the customer registered by the registration unit when purchasing the commodity within commodities that are advertised through advertisement information in a displaying manner different from other commodities.

6. The shopping cart according to claim 1, wherein
the display control unit makes the display perform premium information pop up display during displaying information on the display.

7. The shopping cart according to claim 2, wherein
the display control unit makes the display perform information pop up display during displaying information on the display.

8. A method, comprising:
registering a customer who operates a cart conveying commodities; and
displaying premium information indicating premium which is offered to the customer registered within premiums offered to customers when purchasing commodity.
